(19) United States
(12) Patent Application Publication
(10) Pub. No.: US 2013/0049630 A1
(43) Pub. Date: Feb. 28, 2013

(54) METHOD FOR OPERATING A HIGH-PRESSURE DISCHARGE LAMP ON THE BASIS OF A LOW FREQUENCY SQUARE WAVE OPERATION AND A PARTIALLY HIGH FREQUENCY OPERATION FOR ARC STABILIZATION AND COLOR MIXING

(71) Applicants: Herbert Kaestle, Traunstein (DE); Marko Kaening, Muenchen (DE); Markus Berger, Augsburg (DE)

(72) Inventors: Herbert Kaestle, Traunstein (DE); Marko Kaening, Muenchen (DE); Markus Berger, Augsburg (DE)

(73) Assignee: OSRAM AG, Muenchen (DE)

(21) Appl. No.: 13/641,142

(22) PCT Filed: Apr. 19, 2011
(86) PCT No.: PCT/EP2011/056238

§ 371 Date: Oct. 15, 2012

(30) Foreign Application Priority Data
May 12, 2010 (DE) 102010028921.3

(51) Int. Cl. H05B 41/14

(52) U.S. Cl. 315/287

(57) ABSTRACT

In various embodiments, a method for operating a high-pressure discharge lamp is provided. The method may include: during a first time slice, a voltage is applied to the high-pressure discharge lamp at a first frequency and said voltage is modulated with a second frequency and a first modulation level, during a second time slice, a voltage is applied to the high-pressure discharge lamp at a third frequency and said voltage is modulated with a fourth frequency and a second modulation level, and during a third time slice, a voltage is applied to the high-pressure discharge lamp at a fifth frequency.

### TECHNICAL FIELD

The invention relates to a method for operating a high-pressure discharge lamp. The invention also relates to an operating device which carries out said method.

### BACKGROUND ART

The invention is based on a method for operating a high-pressure discharge lamp according to the preamble of the main claim.

A mostly relatively low frequency square wave lamp current supply, as illustrated in FIG. 1, is used with rapid commutation for operation of high-pressure discharge (HID) lamps.

This operating method applies, in particular, for the operation of standard HCI lamps, although said method can also be used under certain circumstances for operation of mercury-free molecular radiation-dominated lamps.

The current commutation serves to hinder the one-sided electrode erosion and must be carried out with sufficiently rapid pole-reversal so that the lamp does not extinguish during commutation.

The commutation time should typically be in the region of <100 μsec.

The commutation frequency is generally chosen such that, firstly, the short-lived discontinuities during the commutation procedure do not show in the light as flickers and, secondly, that the acoustic emissions both from the electric ballast and from the hot lamp do not fall within the audible range.

The commutation frequency should be selected, where possible, to lie in the range between 50 Hz and 200 Hz.

The best results are achieved if the commutation frequency is synchronized to the mains at 100 Hz, so that the low-frequency and readily visible mixing modes between the oscillations during the commutation transitions and any ripple in the mains supply are suppressed.

However, the commutation frequency should not be placed above the hearing range at >20 kHz, so that on operation of the lamp, the acoustic self-resonance of the discharge arc which, in common lamp geometries lie between 20 kHz and 150 kHz, are not arbitrarily excited. A resonant excitation of the discharge arc would lead, in most cases, to arc fluctuation and arc instability which, eventually, could lead to extinguishing of the lamp or even to destruction of the lamp.

Using the simple square-wave operation described above, most standardized HID lamps can usually be operated without significant arc instabilities and arc deflections.

However, it is different in the case of special lamp geometries with large aspect ratios, i.e. lamps with a large ratio of lamp vessel length to lamp vessel diameter or arc length to diameter, or in the case of lamps with special filling systems based on molecular radiation-dominated emission which generally leads to enhanced arc constriction and the associated increased sensitivity to acoustic resonance.

In such cases, apart from the possibility of the excitation of stability-reducing acoustic self-resonance, the possibility also arises that, depending on the orientation of the arc, such as the vertical or horizontal discharge position, said arc is systematically deflected upwardly from the axial center thereof as a result of upward forces in the hot lamp, and is therefore formed into an arc shape between the electrodes.

Said arc-shaped deflections lead, in general, to changes in the electrical plasma operating parameters, such as the arc voltage or the position of the acoustic self-resonances, due to changes in the effective arc length, although said parameters are of great importance for stable operation of the arc with an electric ballast device (EVG).

Systematic arc deflection of this type therefore leads, as a rule, to problems in the electric operation of the lamp. In order to avoid such arc deflections which are usually caused by upward forces and for general stabilization of discharge arcs with high aspect ratios, the operational methods used for arc straightening can be applied.

Apart from arc deflection, in the case of HID lamps having large aspect ratios, as used in high-efficiency lamps or molecular radiation-dominated lamps, ‘color segregation’ must also be suppressed.

Color segregation is understood to mean the uneven distribution of filling components in arc plasma in the lamp, leading to different light parameters between the upper and lower part of the lamp.

Color segregation occurs particularly in the vertical lamp operation orientation.

In order to prevent color segregation, particular acoustic self-resonances of the lamp can be excited. This is referred to as excitation of a 2A resonance.

The simplest method for specific excitation of a particular acoustic self-resonance in the lamp is not to operate the lamp, as usual, in the low frequency square wave mode, but rather to operate the arc with an alternating voltage or alternating current at half the relevant frequency of the acoustic self-resonance.

In contrast to square wave operation, reference is made in this context to a high frequency operation, hereinafter called “direct drive”. The following paragraph describes the dosed excitation of a 2A mode for suppression of arc deflection or for stabilizing the arc with arc straightening.

A known operating method which leads, via 2A excitation, to arc stabilization and does not permit any color segregation is simple square wave operation, as shown in FIG. 2a, with simple sequential direct drive, wherein, out of square-wave mode, an operating frequency of, for example, 40 kHz is set in direct drive for a short time, by means of which, over the length of the time slice, excitation of a particular acoustic self-resonance, for example, 2A resonance can be activated. FIG. 2b shows a section of the direct drive with an operating frequency of 40 kHz.

U.S. Pat. No. 6,437,517B1 and EP 1434471 disclose methods which operate the gas discharge lamp with sequential direct drive. For this purpose, two different frequencies are applied to the lamp for exciting two different acoustic resonances. By means of continuous operation in direct drive, however, the modulation of both frequencies can only be varied in relation to one another with regard to the modulation depth thereof, whilst the absolute modulation depths of the two frequencies cannot be adjusted independently of one another. These operating methods therefore cannot be reliably used with all lamp types and are, in part, technically difficult to implement.

### OBJECT

It is an object of the invention to provide a method for operating a high-pressure discharge lamp wherein the discharge arc is straightened and shows increased operating stability in all operating positions (2A-excitation) whilst color segregation is also suppressed by color mixing (2L-excitation), the absolute modulation depth of both high frequency excitations being adjustable independently of one another.

### SUMMARY

This aim is achieved, according to the invention through the features of claim 1.

In order to avoid separation of the filling components, the operating methods of color mixing must be applied.

Separation of filling components can be hindered by targeted excitation of a special acoustic self-resonance in the discharge arc of the lamp with a longitudinal mode character (2L-excitation), since said mode leads, in the lamp vessel to the formation of overreaching flow cells which counteract separation of the filling components.

Said excitation is referred to as excitation of the 2^{nd} longitudinal acoustic mode for the purpose of color segregation suppression or for the purpose of color mixing.

Specific excitation of the 2L mode in the lamp must be carried out by means of the electrical operating device.

Similarly to color mixing, in arc straightening, acoustic self-resonance is also specifically excited (2A-excitation) in the discharge arc by the electrical operating device, said self-resonance also not leading, as a result of the modal properties thereof, to the generally usual arc instabilities, but rather causing increased stability of the arc in the axial direction.

The self-resonances coming into consideration in this regard are mostly those with an azimuthal mode structure.

Said excitation is referred to as excitation of the 2^{nd} azimuthal acoustic mode for the purpose of arc straightening.

The excitation can take place via a direct high frequency operation (or ‘direct drive’), via amplitude modulation on the low frequency square wave voltage, or by mixing said operating types. According to the invention, particular azimuthal resonance frequencies are excited simultaneously with particular longitudinal resonance frequencies, the high frequency operation being combined with a low frequency square wave voltage for operation of the gas discharge lamp. The excitation can take place either by means of one direct drive at two different frequencies in two different time slices or a combination of two different direct drives at two different time slices and two different frequencies with a low frequency square wave operation or by combination of one direct drive at one frequency with a low frequency square wave operation that is amplitude modulated with a different high frequency. A circuit arrangement for carrying out this method is known from WO2008/083852A1, the disclosure content of which is hereby included by reference.

Further advantageous developments and embodiments of the operating method according to the invention are disclosed in the further dependent claims and the following description.

### BRIEF DESCRIPTION OF THE DRAWING(S)

Further advantages, features and details of the invention are disclosed in the following description of exemplary embodiments and on the basis of the drawings in which the same or functionally similar elements are identified with the same reference signs. In the drawings:

FIG. 1 is a graphical representation of a known square wave lamp operating voltage according to the prior art,

FIG. 2a is a graphical representation of a known lamp operating voltage with arc straightening by means of excitation of azimuthal modes by a direct drive in combination with a low frequency square wave drive according to the prior art,

FIG. 2b is a detail view of the direct drive of the lamp voltage for exciting the azimuthal modes of FIG. 2a,

FIG. 3a is a graphical representation of the lamp operating voltage of a first embodiment of the method according to the invention with arc straightening using dual sequential direct drive in combination with a low frequency square wave drive for exciting the azimuthal and longitudinal modes,

FIG. 3b is a detail view of the first high frequency direct drive of the lamp voltage for exciting the azimuthal modes of FIG. 3a,

FIG. 3c is a detail view of the second high frequency direct drive of the lamp voltage for exciting the longitudinal modes of FIG. 3a,

FIG. 4a is a graphical representation of the lamp operating voltage of a second embodiment of the method according to the invention with arc straightening using sequential direct drive for exciting the azimuthal modes and a high frequency voltage modulated onto the low frequency voltage for exciting the longitudinal modes,

FIG. 4b is a detail view of the direct drive of the lamp voltage for exciting the azimuthal modes of FIG. 4a,

FIG. 4c is a detail view of the amplitude modulation frequency of the lamp voltage for exciting the longitudinal modes of FIG. 4a,

FIG. 5a is a graphical representation of the lamp operating voltage of a third embodiment of the method according to the invention with arc straightening using sequential direct drive for exciting the azimuthal modes and a high frequency voltage modulated onto the low frequency voltage and onto the voltage of the direct drive for exciting the longitudinal modes,

FIG. 5b is a detail view of the amplitude-modulated direct drive of the lamp voltage for exciting the azimuthal and longitudinal modes of FIG. 5a,

FIG. 5c is a detail view of the amplitude modulation frequency of the lamp voltage for exciting the longitudinal modes of FIG. 5a,

FIG. 6a is a graphical representation of the lamp operating voltage of a fourth embodiment of the method according to the invention with arc straightening using a high frequency voltage sequentially modulated onto the low frequency voltage for exciting the longitudinal and azimuthal modes,

FIG. 6b is a detail view of the two sequential amplitude modulation frequencies of lamp voltage for exciting the azimuthal and longitudinal modes of FIG. 6a.

### PREFERRED EMBODIMENT OF THE INVENTION

The position of the active azimuthal self-resonance frequencies for arc straightening depends, firstly, on the geometry of the lamp (length, aspect ratio) and, secondly, on the general operating parameters of the lamp, for example, pressure, temperature, filling gas, filling components, power rating, etc. With the present lamps, the azimuthal self-resonance modes are in the region between 20 kHz and 150 kHz, typically approximately 80 kHz.

The effective longitudinal self-resonance frequencies also depend on the geometry of the lamp (length, aspect ratio) and on the general operating parameters of the lamp, for example, pressure, temperature, filling gas, filling components, power rating, etc. With the present lamps, the longitudinal self-resonance modes are in the region between 20 kHz and 60 kHz, and typically at approximately 26 kHz.

If it is required to excite an azimuthal mode in the lamp at 60 kHz with the electronic operating device in direct drive, the electronic operating device must drive the lamp sinusoidally at precisely half the operating alternating frequency, at 30 kHz. If an azimuthal mode is to be excited in the lamp at 80 kHz, the electronic operating device must drive the lamp sinusoidally at precisely half the operating alternating frequency, at 40 kHz.

The amplitude spectrum of this supply voltage or this supply current would have a single frequency component at 30 kHz or at 40 kHz and the associated power spectrum, that is, the spectrum of the product of current and voltage, would have a single frequency line at precisely double the frequency, that is, at 60 kHz or at 80 kHz, with which the relevant acoustic mode is excited in the lamp.

In addition to the frequency line at 80 kHz, the power spectrum also has, in general, a component at f=0 Hz which corresponds to the mean converted power value in the lamp.

The advantage of the direct drive is that said drive can be realized with simple circuit arrangements in a half-bridge and the ballast unit can thus be constructed with relatively little effort for the electronics.

The disadvantage of direct drive is that it is relatively difficult to control the excitation intensity of the desired acoustic self-resonance mode, since with direct drive, the total modulation level is always 100% and the two degrees of freedom, the size of the sweep region and thus of the frequency region that is periodically passed through, or the sweep repetition frequency can only be varied to a certain extent.

The size of the sweep region cannot be widened without limitation because, usually arising in the immediate vicinity of the arc straightening resonance that is aimed for, are further acoustic self-resonance frequencies, which should not be excited where possible because said further frequencies would be noticeable by negative effects on arc stability when excited.

The sweep repetition rate or sweep repetition frequency can usually also not be lowered without limitation, since unavoidable power variations during the sweep procedure can only be compensated for with a great effort in terms of control technology and said power variations would become noticeable particularly at frequencies <50 Hz as a fluctuation in the light output.

However, an alternative method for targeted and dosed excitation of a special acoustic self-resonance frequency of the discharge arc can be achieved by means of the operating device with square wave operation.

This is referred to as square wave AM modulation.

In low frequency square wave operation, for electrical excitation of a specific lamp self-resonance frequency, the relevant frequency component must be applied additively as an amplitude modulation to the square wave lamp supply.

In said modulation method, the value of the frequency component modulated on matches the value of the self-resonance frequency actually aimed for in the lamp and the frequency component modulated on appears directly in the power spectrum of the square wave signal.

Frequency doubling, as in the case of direct drive, does not take place in this case.

If, for example, the self-resonance frequency actually aimed for in the lamp is 26 kHz, the frequency component modulated on must also be 26 kHz.

The advantage of the amplitude modulation applied is that the excitation intensity of the acoustic self-resonance aimed for can be clearly adjusted by means of the depth of the modulation or the modulation level, which itself would enable adaptation to individual lamps.

However, a disadvantage of the amplitude modulation in square wave operation is the complex technical realization thereof in the electric ballast, for which reason said modulation has seldom been implemented. The modulation level of the amplitude modulation for effective modulation is between 5% and 30%, and is typically 10%.

The method according to the invention for operating a mercury-free molecular radiation-dominated high-pressure discharge (HID) lamp which requires both specific acoustic excitation both for arc straightening and the acoustic excitation aimed for to suppress the color segregation will now be described.

As a result of the acoustic properties of this lamp type, it is necessary that for both frequency inputs, the excitation intensity of each can be adjusted to a reduced level specifically and independently of the other.

In order to bring this about, the following operating methods according to the invention are proposed:

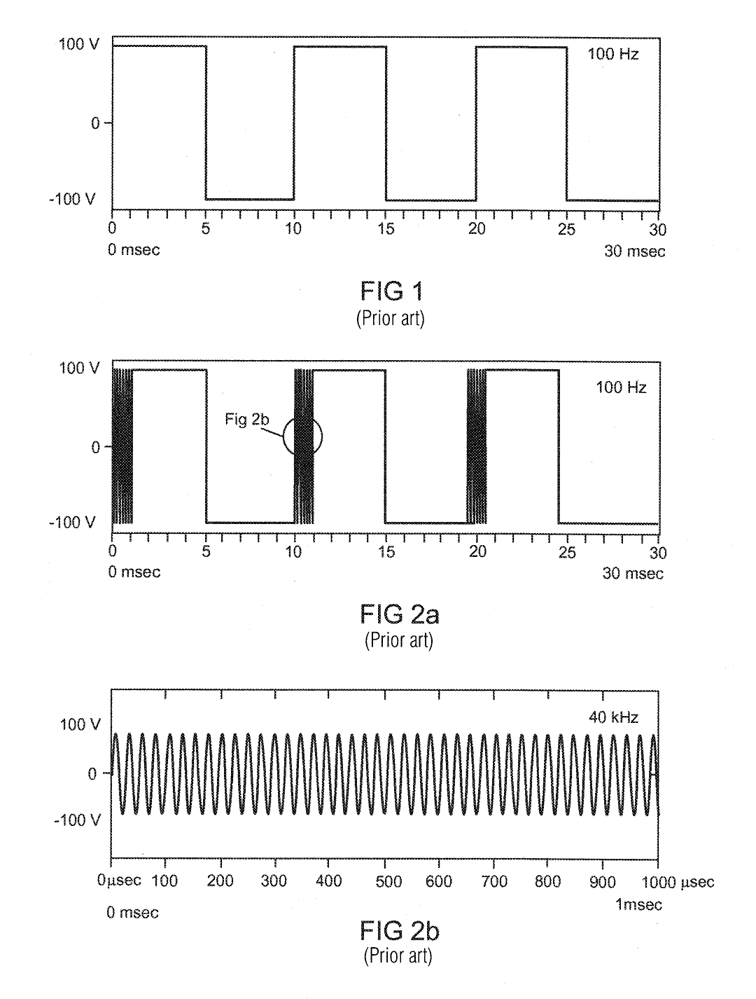

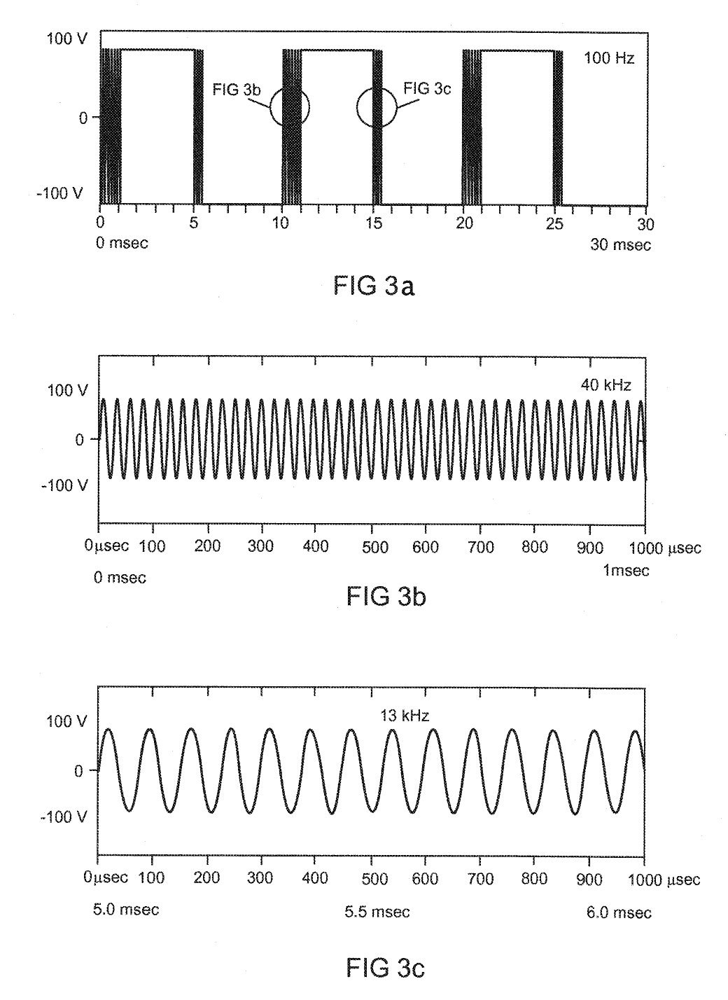

FIG. 3a shows a graphical representation of the lamp operating voltage of a first embodiment of the method according to the invention with arc straightening using dual sequential direct drive in combination with a neutral square wave signal for excitation of the azimuthal and longitudinal modes. This operating method is a dual sequential direct drive in combination with a neutral square wave signal, wherein in two different time slices, two different operating frequencies are applied, with which two different acoustic self-resonances can be excited with adjustable strength, the underlying operation of the lamp taking place via the square wave mode as shown in FIG. 1.

Excitation of the 2^{nd} azimuthal self-resonance for the purpose of arc straightening, as shown in FIG. 3b, is carried out sequentially via short-term operation of the lamp in direct drive mode at 40 kHz, wherein by means of the setting of the chronological pulse duty factor of the square wave mode and the direct drive mode, the absolute excitation intensity for the acoustic self-resonance can be set.

If the period duration of square wave operation is, for example, 10 ms, a modulation depth of 10% can be implemented with a direct drive time slice of 1 ms.

The excitation of the 2^{nd} longitudinal self-resonance (2L-resonance) for the purpose of color mixing, as shown in FIG. 3c, is carried out sequentially with short-period operation of the lamp in direct drive mode at 13 kHz, wherein by setting the chronological pulse duty factor of the square wave mode and the direct drive mode, the absolute excitation intensity for the acoustic self-resonance can be set.

If the period duration of square wave operation is, for example, 10 ms, a modulation depth of 12% can be realized with a direct drive time slice of 1.2 ms.

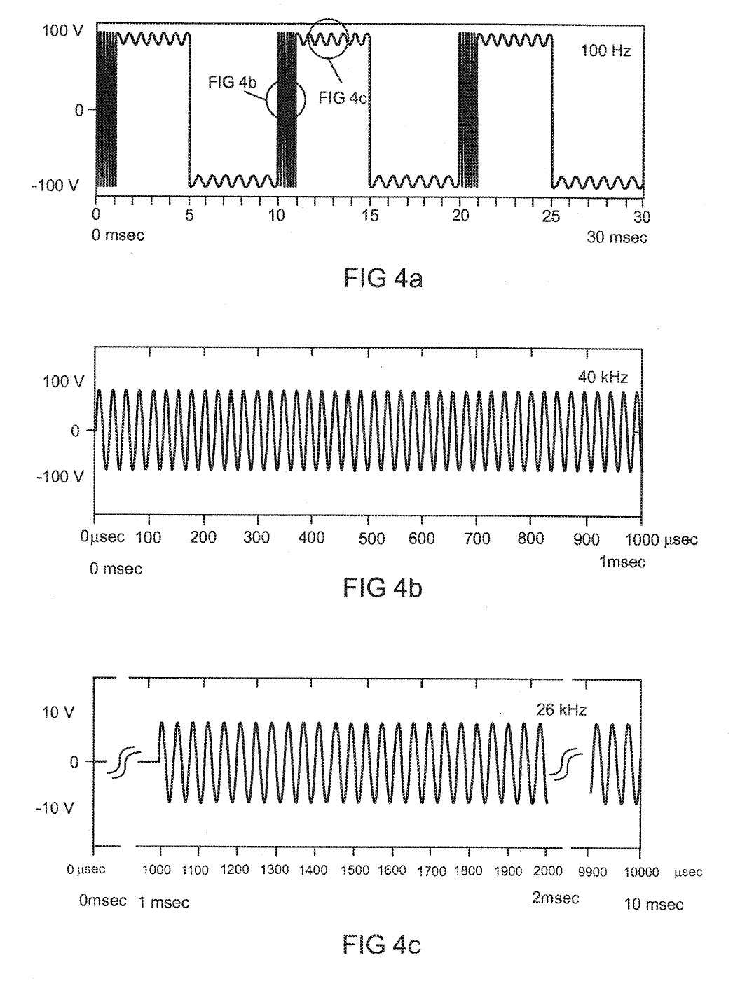

FIG. 4a shows a graphical representation of the lamp operation voltage for a second embodiment of the inventive method with arc straightening using sequential direct drive for exciting the azimuthal modes and high frequency voltage modulated onto the low frequency voltage for exciting the longitudinal modes.

Excitation of the 2^{nd} azimuthal self-resonance for the purpose of arc straightening, as shown in FIG. 4b, is carried out sequentially by means of short-period operation of the lamp in direct drive mode at 40 kHz, wherein via the setting of the chronological pulse duty factor of the square wave mode and the direct drive mode, the excitation intensity for acoustic self-resonance can be set.

If the period duration of square wave operation is, for example, 10 ms, with a direct drive time slice of 1 ms, a modulation depth of 10% can be realized.

Excitation of the 2^{nd} longitudinal self-resonance (2L-resonance) for the purpose of color mixing, as FIG. 4c shows, is carried out by application of an amplitude modulation to the amplitudes of the square wave. The AM modulation frequency is 26 kHz. The adjustable AM modulation depth determines the excitation intensity for the 2L color mixing resonance.

The amplitude modulation can optionally be activated throughout the whole period, that is, during the pure square wave mode phase and the direct drive phase (see the passage concerning the third embodiment) or only during the pure square wave phase and can be switched off during the short-period direct drive phase. FIG. 4b shows a graphical representation of lamp voltage during the time slice in which the direct drive is active. FIG. 4c shows a graphical representation of the lamp voltage during the time slice in which the lamp is operated with a modulated low frequency voltage. In this embodiment, it is advantageous that no side bands form round the direct drive line in the excitation spectrum as a result of the switched off amplitude modulation during the direct drive phase, which side bands could lead to excitation of unwanted acoustic resonances in an uncontrolled manner in the lamp.

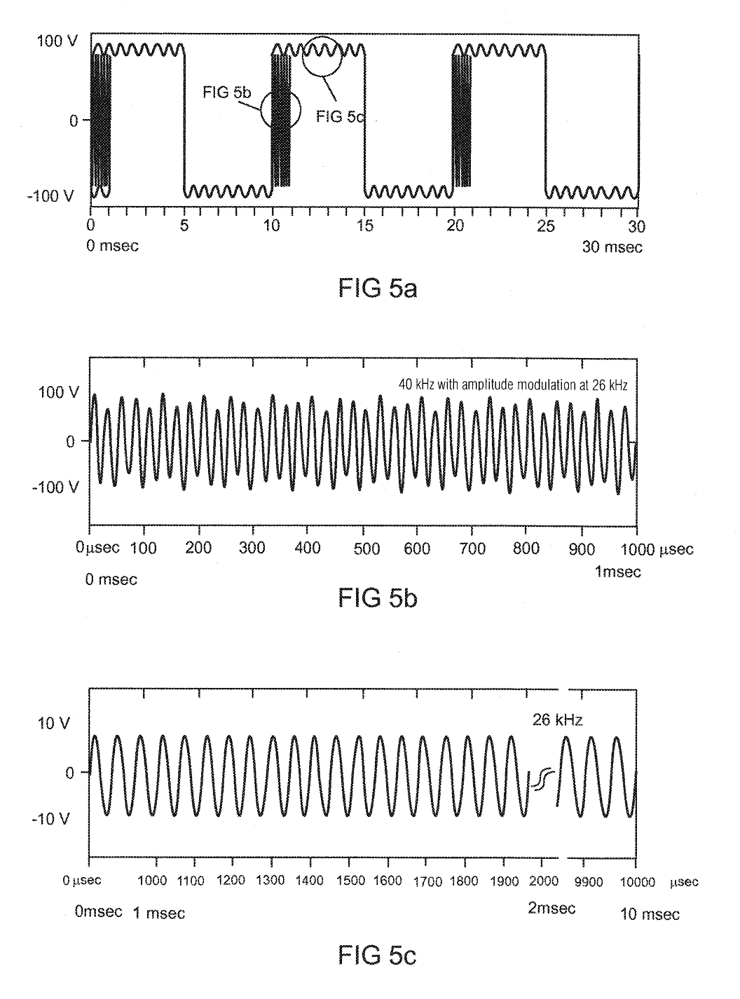

A third embodiment of the operating method according to the invention is shown by FIG. 5. FIG. 5a shows a graphical representation of the lamp operating voltage of the third embodiment of the method according to the invention having arc straightening using sequential direct drive for exciting the azimuthal modes and high frequency voltage modulated onto the low frequency voltage and onto the voltage of the direct drive for exciting the longitudinal modes. This is a variant of the method described above in the second embodiment. In this case, the amplitude modulation for color mixing is not only applied to the low frequency square wave, but also to the high frequency sinusoidal voltage for arc straightening. FIG. 5b shows the modulated sinusoidal voltage in the direct drive which is modulated using amplitude modulation at 26 kHz. FIG. 5c shows a section of the square wave-shaped voltage, which is also modulated with amplitude modulation at 26 kHz.

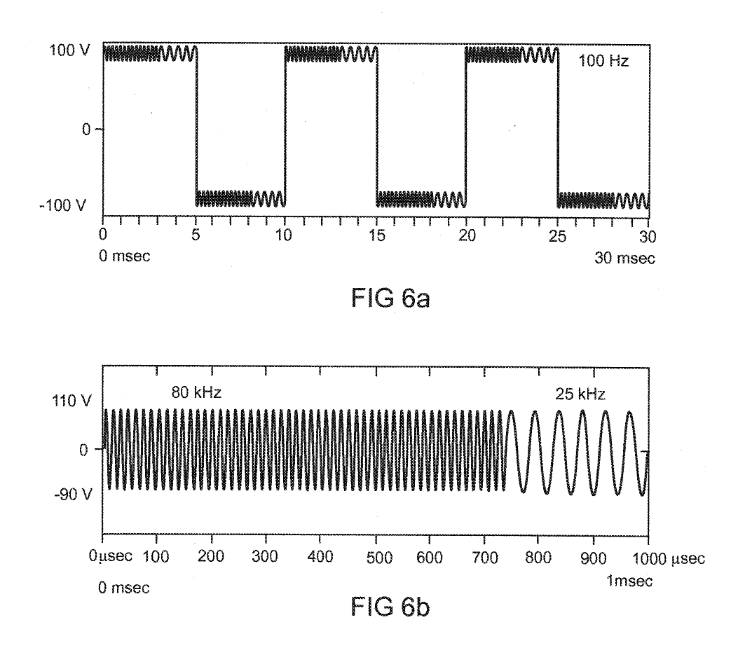

FIG. 6a shows a graphical representation of the lamp operating voltage of a fourth embodiment of the method according to the invention with arc straightening using high frequency voltage modulated onto the low frequency voltage in order to excite the longitudinal and azimuthal modes. In square wave mode, this operating method would be dual sequential AM operation wherein the amplitude modulation is operated, in each case, in two different time slices at two different frequencies. The excitation intensity of both acoustic self-resonances aimed for can be set by means of the respective associated AM depth. FIG. 6b shows a detail view of the lamp voltage for exciting the azimuthal and longitudinal modes of FIG. 6a. The section has been selected so that the change between the two modes is visible.

1. A method for operating a high-pressure discharge lamp, the method comprising:
applying a voltage during a first time slice to the high-pressure discharge lamp at a first frequency and modulating said voltage with a second frequency and a first modulation level,
applying a voltage during a second time slice to the high-pressure discharge lamp at a third frequency and modulating said voltage with a fourth frequency and a second modulation level, and
applying a voltage during a third time slice to the high-pressure discharge lamp at a fifth frequency.

2. The method as claimed in claim 1,
wherein the first frequency is a low frequency in the range of 50 Hz to 200 Hz, the first modulation level is 0, the third frequency is a high frequency in the range of 20 kHz to 150 kHz, the second modulation level is 0 and the fifth frequency is a high frequency in the range of 10 kHz to 30 kHz.

3. The method as claimed in claim 1,
wherein the first frequency is a low frequency in the range of 50 Hz to 200 Hz, the first modulation level is in the range of 5% to 30%, the second frequency is a high frequency in the range of 20 kHz to 60 kHz, the third frequency is a high frequency in the range of 20 kHz to 150 kHz, the second modulation level is 0 and the length of the third time slice is 0.

4. The method as claimed in claim 1,
wherein the first frequency is a low frequency in the range of 50 Hz to 200 Hz, the first modulation level is in the range of 5% to 30%, the second frequency is a high frequency in the range of 20 kHz to 60 kHz, the third frequency is a high frequency in the range of 20 kHz to 150 kHz, the second modulation level is in the range of 5% to 30%, the fourth frequency is a high frequency in the range of 20 kHz to 60 kHz, and the length of the third time slice is 0.

5. The method as claimed in claim 1,
wherein the first frequency is a low frequency in the range of 50 Hz to 200 Hz, the first modulation level is in the range of 5% to 30%, the second frequency is a high frequency in the range of 10 kHz to 30 kHz, the third frequency is a high frequency in the range of 20 kHz to 150 kHz, the second modulation level is 0 and the fifth frequency is a high frequency in the range of 10 kHz to 30 kHz.

6. The method as claimed in claim 1,
wherein the first frequency is a low frequency in the range of 50 Hz to 200 Hz, the first modulation level is in the range of 5% to 30%, the second frequency, for a first part of the first time slice, is a high frequency in the range of 20 kHz to 60 kHz, and, for a second part of the first time slice, is a high frequency in the range of 20 kHz to 150 kHz, the length of the second time slice is 0 and the length of the third time slice is 0.

7. An operating device for operating a high-pressure discharge lamp,
wherein said device carries out a method for operating a high-pressure discharge lamp, the method comprising:
applying a voltage during a first time slice to the high-pressure discharge lamp at a first frequency and modulating said voltage with a second frequency and a first modulation level,
applying a voltage during a second time slice to the high-pressure discharge lamp at a third frequency and modulating said voltage with a fourth frequency and a second modulation level, and
applying a voltage during a third time slice to the high-pressure discharge lamp at a fifth frequency.

8. The operating device as claimed in claim 7,
wherein the high-pressure discharge lamp is a mercury-free, molecular radiation-dominated high-pressure discharge lamp.

9. The operating device as claimed in claim 7,
wherein the high-pressure discharge lamp has a large length to diameter ratio of the lamp vessel thereof.

10. The method as claimed in claim 2,
wherein the third frequency is a high frequency of 40 kHz, and the fifth frequency is a high frequency of 13 kHz.

11. The method as claimed in claim 3,
wherein the first modulation level is 10%, the second frequency is a high frequency of 26 kHz, and the third frequency is a high frequency of 40 kHz.

12. The method as claimed in claim 4,
wherein the first modulation level is 10%, the second frequency is a high frequency of 26 kHz, the third frequency is a high frequency of 40 kHz, the second modulation level is 10%, the fourth frequency is a high frequency of 26 kHz.

13. The method as claimed in claim 5,
wherein the first modulation level is 10%, the second frequency is a high frequency of 13 kHz, the third frequency is a high frequency of 80 kHz, and the fifth frequency is a high frequency of 13 kHz.
